(19) United States
(12) Patent Application Publication
(10) Pub. No.: US 2006/0184619 A1
(43) Pub. Date: Aug. 17, 2006

(54) Method and system for providing programs to user operable device

(75) Inventors: Atsushi Tano, Kariya-city (JP); Masahiro Kumamoto, Tokyo (JP)

Correspondence Address: POSZ LAW GROUP, PLC, 12040 SOUTH LAKES DRIVE, SUITE 101, RESTON, VA, 20191, US

(73) Assignee: DENSO WAVE INCORPORATED, Tokyo (JP)

(21) Appl. No.: 11/354,996

(22) Filed: Feb. 16, 2006

(30) Foreign Application Priority Data
Feb. 16, 2005 (JP) 2005-039128
Dec. 21, 2005 (JP) 2005-368126

(51) Int. Cl. G06F 15/16

(52) U.S. Cl. 709/203; 709/217

(57) ABSTRACT

In a server system, a first receiving unit receives a request including a search requirement that a target program should meet and sent from a user operable device through a communication network. A search unit searches the plurality of programs to retrieve information indicative of at least one program. The at least one program meets the search requirement. A first download unit creates a first page of information indicative of the retrieved information and viewable by the user operable device, and downloads the first page of information to the user operable device through the communication network.

### CROSS REFERENCE TO RELATED APPLICATION

This application is based on Japanese Patent Applications 2005-039128 and 2005-368126 filed on Feb. 16, 2005 and Dec. 21, 2005, respectively. This application claims the benefit of priority from each of the Japanese Patent Applications, so that the descriptions of which are all incorporated herein by reference.

### BACKGROUND OF THE INVENTION

1. Field of the Invention

The present invention relates to methods and systems for accessing a server through a communication network to acquire a desired program. The present invention also relates to methods and systems for providing a program, which a user desires to obtain, to a user-operable device.

2. Description of the Related Art

Various types of application programs haven been installed in handheld information reading terminals, such as barcode readers, for causing them to perform particular roles. Such application programs for handheld information reading terminals haven been developed by software developers in specific software development environments. For example, a software developer proprietarily develops such an application program in the developer's specific software development environment in response to user's requests.

This application program development set forth above however requires detailed arrangements between a software developer and a user. If a definitively delivered application program cannot operate to meet user's expectations, redevelopment of the application program must be required, causing the time and cost for developing an application program to rise.

The applicant of the present application therefore has provided development programs that allow a user to easily develop an application program in GUI (Graphical User Interface) environment.

The application-program development environment based on the development programs is served to be installed individually in each of user's stand-alone personal computers. This may cause application programs that can commonly meet functionally-identical user's requirements to be redundantly developed by some of the users.

### SUMMARY OF THE INVENTION

The present invention has been made on the background so that preferable embodiments of the present invention are capable of preventing application programs that can commonly meet functionally-identical user's requirements from being redundantly developed.

According to one aspect of the present invention, there is provided a system. The system according to one aspect includes a server computer storing therein a plurality of programs, and a user operable device communicable with the server computer through a communication network. The user operable device includes a request unit configured to request a search requirement that a target program should meet to the server computer through the communication network. The server computer includes a receiving unit configured to receive the search requirement, and a search unit configured to search the plurality of programs to retrieve information indicative of at least one program. The at least one program meets the search requirement. The server computer also includes a download unit configured to download the retrieved information to the user operable device through the communication network. The user operable device further includes a first display unit configured to display the downloaded information.

According to another aspect of the present invention, there is provided a server system storing therein a plurality of programs and communicable with a user operable device through a communication network. The server system includes a first receiving unit configured to receive a request including a search requirement that a target program should meet and sent from the user operable device through the communication network. The server system also includes a search unit configured to search the plurality of programs to retrieve information indicative of at least one program, the at least one program meeting the search requirement. The server system further includes a first download unit configured to create a first page of information indicative of the retrieved information and viewable by the user operable device and to download the first page of information to the user operable device through the communication network.

According to a further aspect of the present invention, there is provided a method of providing at least one of a plurality of programs to a user operable device through a communication network. The method includes receiving a request including a search requirement that a target program should meet and sent from the user operable device through the communication network, and searching the plurality of programs to retrieve information indicative of at least one program. The at least one program meets the search requirement. The method includes creating a first page of information indicative of the retrieved information and viewable by the user operable device, and downloading the first page of information to the user operable device through the communication network.

### BRIEF DESCRIPTION OF THE DRAWINGS

Other objects and aspects of the invention will become apparent from the following description of embodiments with reference to the accompanying drawings in which:

FIG. 1 is a system configuration diagram schematically illustrating an example of the structure of a server-client system according to a first embodiment of the present invention;

FIG. 2 is a block diagram schematically illustrating an example of the functional structure of the server-client system illustrated in FIG. 1;

FIG. 3A is a flowchart schematically illustrating flow of operations executed by a server and a client according to the first embodiment;

FIG. 3B is a flowchart schematically illustrating flow of operations executed by the server and the client according to the first embodiment;

FIG. 4 is a view schematically illustrating an example of a requirement input Web page displayed on the screen of a display device of the client;

FIG. 5 is a view schematically illustrating an example of an application-program search result Web page displayed on the screen of the display device;

FIG. 6 is a view schematically illustrating an example of the file structure of a fixed assets stock-take program as a representative of application programs stored in the server;

FIG. 7 is a view schematically illustrating an example of a program structure Web page displayed on the screen of the display device;

FIG. 8 is a view schematically illustrating an example of the structure of a program simulator of the server;

FIG. 9 is a view schematically illustrating an example of a program simulator Web page corresponding to the fixed assets stock-take program and displayed on the screen of the display device;

FIG. 10A is a view schematically illustrating an example of the structure of a program module according to the first embodiment;

FIG. 10B is a view schematically illustrating an example of the structure of another program module according to the first embodiment;

FIG. 11 is a view schematically illustrating a specific example of the file structure of a master file according to the first embodiment;

FIG. 12 is a view schematically illustrating a data registration process based on a subroutine according to the first embodiment;

FIG. 13 is a view schematically illustrating an example of a program editor Web page displayed on the screen of the display device;

FIG. 14 is a view schematically illustrating the program editor Web page when dragging and dropping an icon thereon;

FIG. 15 is a view schematically illustrating an example of a detailed setting Web page for setting arguments parameters according to the first embodiment;

FIG. 16 is a view schematically illustrating an example of a program download confirmation Web page displayed on the screen of the display device;

FIG. 17 is a flowchart schematically illustrating flow of operations executed by the server and the client according to the first embodiment;

FIG. 18 is a flowchart schematically illustrating flow of operations executed by the server and the client according to the first embodiment;

FIG. 19 is a view schematically illustrating an example of a release key entry screen displayed on the screen of the display device according to the first embodiment;

FIG. 20 is a view schematically illustrating an example of the structure of storage region of a storage medium according a second embodiment of the present invention;

FIG. 21 is a system configuration diagram schematically illustrating an example of the structure of a server-client system according to a second embodiment of the present invention;

FIG. 22 is a sequence chart schematically illustrating a procedure for obtaining a license key by a reading terminal according to the second embodiment;

FIG. 23 is a view schematically illustrating replacement of a reading terminal into a new one, remove of a storage medium from the reading terminal, and insertion of the removed storage medium into a slot of the new one;

FIG. 24A is a view schematically illustrating an example of configuration of giving license keys to downloaded application programs in one-to-one relationship according to the present invention;

FIG. 24B is a view schematically illustrating another example of configuration of giving license keys to functions of a downloaded application programs, respectively, according to the present invention; and

FIG. 24C is a view schematically illustrating a further example of configuration of giving a license to a plurality of functions of a downloaded application program according to the present invention.

### DETAILED DESCRIPTION OF EMBODIMENTS OF THE INVENTION

Embodiments of the present invention will be described hereinafter with reference to the accompanying drawings.

### First Embodiment

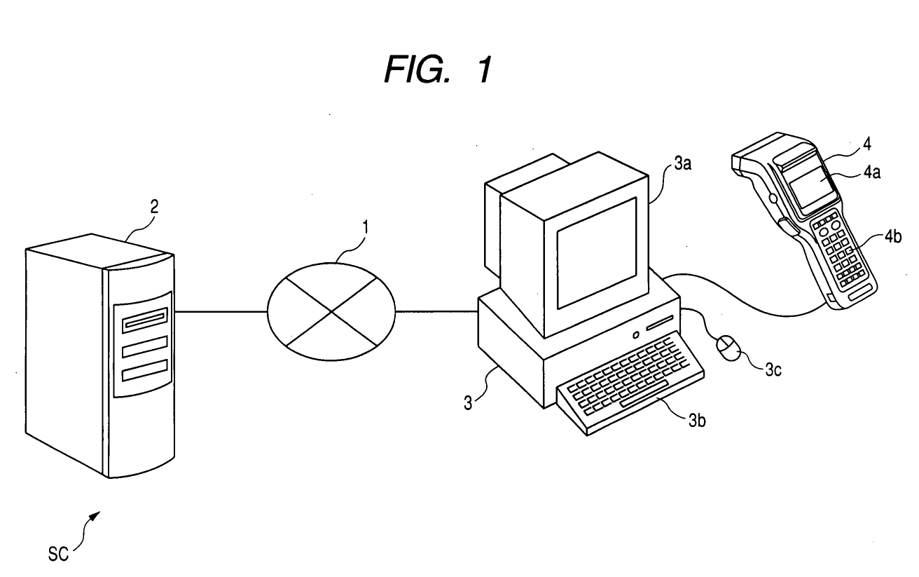

FIG. 1 schematically illustrates an example of the structure of a server-client system SC according to a first embodiment of the present invention. As illustrated in FIG. 1, the server-client system SC includes a server (server computer) 2 communicably linked to the Internet 1 as an example of communication networks; this server 2 serves as a host computer in the system SC. The server 2 has been installed by, for example, a vender for handheld information reading terminals, such as optical information readers, 4; these handheld information reading terminals will be referred to simply as reading terminals hereinafter. The server 2 is operative to download, to the reading terminals 4 through the Internet 1, application programs for causing them to perform particular roles.

The server-client system SC also includes a client (client computer) 3 composed of, for example, a personal computer communicably linked to the Internet 1. The server-client system SC further includes the reading terminals 4 each capable of optically reading out an information code (identification code), such as one-dimensional code, two-dimensional code, and the like.

Each of the reading terminals 4 can establish communications with the client 3 with or without cables. The client 3 and the reading terminals 4 provide a user-operable device, and the user-operable device has been located in, for example, a store that has a plurality of shelves on which a plurality of goods, such as products, parts, documents, and the like, have been correspondingly placed.

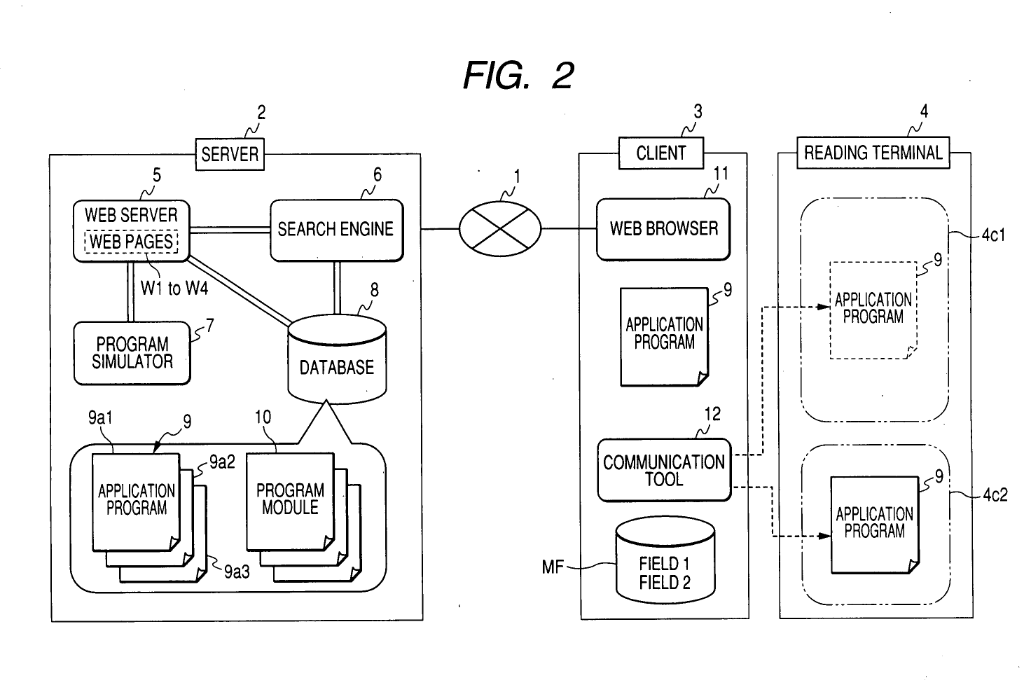

FIG. 2 schematically illustrates an example of the functional structure of the server-client system SC.

The server 2 is composed of at least a CPU and a storage medium. As illustrated in FIG. 2, the server 2 functionally includes a Web server 5, a search engine 6, a program simulator 7, and a database 8. The functions 5 to 7 can be implemented by operations of the server (CPU) 2 based on programs installed therein, and the database 5 has been stored on the storage medium.

The database 8 has stored therein application programs (program files) 9 and program modules 10. The application programs 9 are designed to cause the reading terminals 4 to perform particular tasks. In the first embodiment, the application programs 9 include a fixed assets stock-take program 9a1, a document stock-take program 9a2, and a stock-take data registration program 9a3.

Each of the application programs 9 is composed of some of the program modules 10 in file structure. Each of the program modules 10 is preferably described in a program language that is obtained by improving the BASIC to form a subroutine. A specific example of the file structure of each application program will be described in detail hereinafter.

The Web server 5 includes Web pages, for example, HTML or XML files, that can be viewed using a Web browser. The Web server 5 is operative to perform:

static tasks to download the Web pages to a Web browser through the Internet 1; and

dynamic tasks to run special programs, such as CGIs (Common Gateway Interfaces), in response to user's requests so as to download the results of running the special programs as Web pages.

Specifically, some of the Web pages include fields in which a user (user's Web browser) can enter a request that allows the Web server 5 to run at least one of the special programs corresponding to the request. The Web server sends the result of running the at least one of the special programs to the user's Web browser through the Internet 1.

For example, in the first embodiment, the Web server 5 includes a requirement input Web page W1, a plurality of program structure Web pages W2, a plurality of program simulator Web pages W3 corresponding to the application programs 9, and a plurality of editor Web pages W4 corresponding to the application programs 9.

The application programs 9 are open to the public on the Internet 1 by the operations of the Web server 5 so that they are available by the operations of Web browsers, which will be described hereinafter, through the Internet 1.

A search engine 6 is operative to examine the database 5 for items of data satisfying user's search requirements passed from the Web server 5, such as at least one application program and/or at least one program module, thereby returning the items of data to the Web server 5.

A program simulator 7 is operative to perform a simulation of at least one of the application programs 9 passed from the Web server 5.

In addition, the client 3 is composed of a GUI-installed computer with peripherals including a display device 3a, a keyboard 3b, a mouse 3c as an example of pointing devices, and a storage medium; these peripherals 3a to 3c provide part of the GUI.

Specifically, the client 3 includes a GUI-based Web browser 11 and a communication tool 12.

The Web browser 11 has been installed in the client 3. The Web browser 11 enables a user to access Web servers linked to the Internet 1 and view information downloaded from the Web servers in the form of Web pages using the GUI. In addition, the Web browser 11 allows a user to enter requests to Web servers using the GUI.

Specifically, the GUI can graphically display information on the screen of the display device 3a. The GUI also permits a user to communicate with the client 3 by manipulating icons (pictures) and windows on the screen of the display device 3a with the keyboard 3b and/or the mouse 3c.

The communication tool 12 consists of programs that has been downloaded from the server 2 to be installed in the client 3, and or applets, such as Java® applets, come with an operating system installed in the client 3.

In addition, the client 3 includes at least one master file MF named as, for example, “MASTER.DAT”. As described in FIG. 1, the master file MF contains a plurality of records each of which consists of a plurality of fields (field 1, field 2, . . . ) such that data items stored in the corresponding fields in each record are associated with each other.

For example, the types of the goods have been stored in the corresponding fields 2 of the records, respectively. Labels to which unique identification codes have been written have been attached to the goods, respectively. The unique identification codes corresponding to the goods serve as control numbers of the goods, and have been stored in the fields 1 so as to correspond to the names stored in the fields 1, respectively. As the identification codes, JAN codes, CODE 128, which are examples of barcodes, and QR codes as an example of two-dimensional codes have been used.

Each of the reading terminals 4 is composed of a GUI-installed computer with peripherals including a display device 4a and a key portion 4b.

Specifically, each of the reading terminals 4 for example can employ any one of two types of application-program execution systems (application-execution programs).

The application-program execution system 4c1 of one of the two types is an operating system (OS) that is designed to execute the source code of an application program 9 by translating parameters therein line by line and doing the specified operations immediately; these parameters constitute a parameter file.

The application-program execution system 4c2 of the other thereof is designed to receive an object (object code) into which the source code of an application program 9 is translated by the communication tool 12, and to run it directly.

Next, operations of the server-client system SC will be described hereinafter.

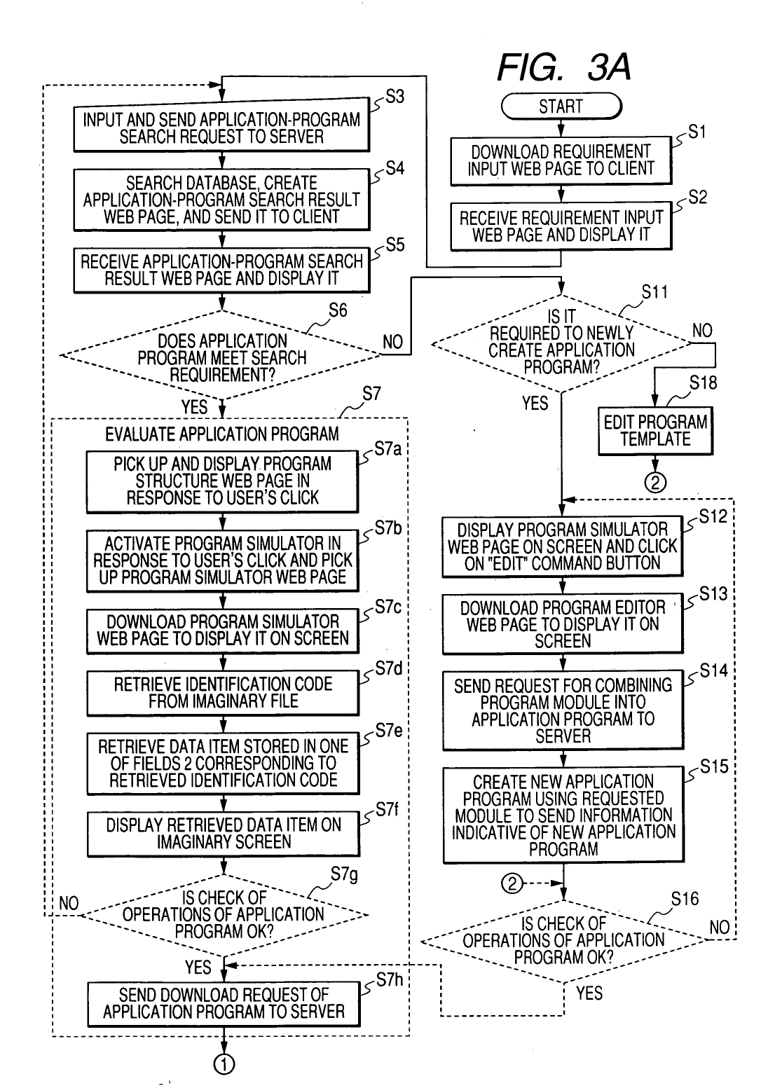

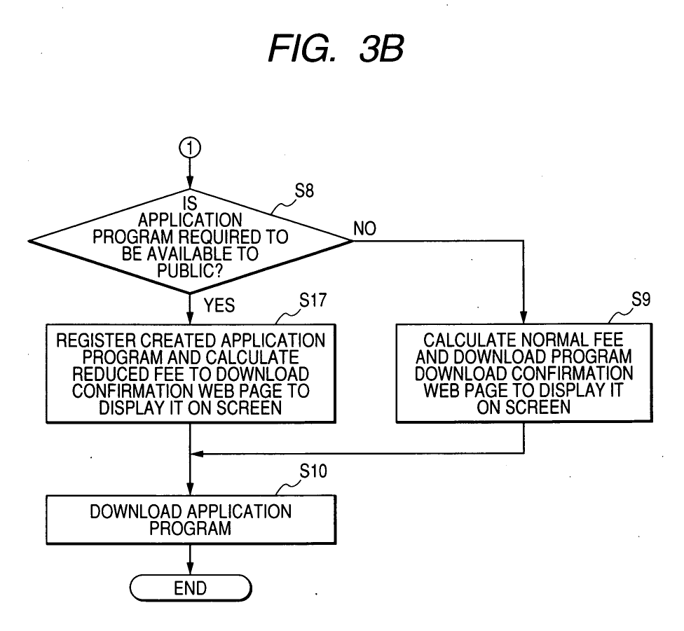

FIGS. 3A and 3B schematically illustrate flow of operations executed by the server 2 and client 3.

In step S1 of FIG. 3A, a user activates the Web browser 11 to access the Web server 5 of the server 2 so that the Web server 2 picks up the requirement input Web page W1 and downloads it to the client 3 through the Internet 1. Thereafter, the server 2 waits until a request (requirement) is sent from the Web browser 11 in step S1.

The Web browser 11 of the client 3 receives the downloaded requirement input Web page W1 and graphically displays it on the screen of the display device 3a in step S2.

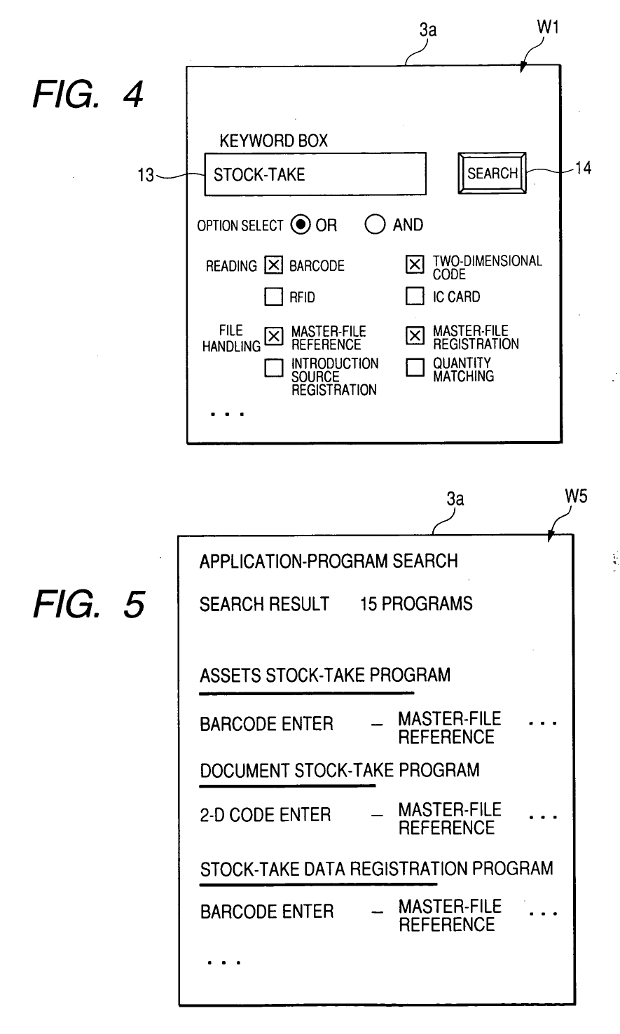

FIG. 4 schematically illustrates an example of the requirement input Web page W1 displayed on the screen of the display device 3a.

As illustrated in FIG. 4, the requirement input Web page W1 contains a keyword (text) box 13, a “search” command button 14; “option select” option buttons OB1 and OB2, “reading target select” check boxes CH1 to CH4, and “file-handling” check boxes CH5 to CH8.

The keyword box 13 allows a user to enter keywords for searching a desirable one of the application programs 9. The “search” command button 14 is a clickable button such that click on the button 14 permits the client 3 to send, to the server 2, search requirements that a target application program 9 should meet; this search requirements are input on the requirement input Web page W1 as application-program search request (requirement).

The option buttons OB1 to OB2 and the check boxes CH1 to CH8 allow a user to input the search requirements.

Specifically, the “reading target select” check boxes CH1 to CH4 permit a user to select at least one of reading-target types including “barcode, two-dimensional code”, “RFID (Radio Frequency Identification)”, and “IC card”.

The “file-handling” check boxes CH5 to CH8 allow a user to select at least one of file-operations including “master-file reference”, “master-file registration”, “registration of source of introduction”, and “quantity matching”. For example, the file-operation of “master-file reference” is indicative of referring to the master-file MF, and the file-operation of “master-file registration” is indicative of registering data items in the master file MF.

The option button OB1 means “OR operator”, and the “option button OB2” means “AND operator”.

Specifically, as illustrated in FIG. 4, if a user checks CH1, CH2, CH5 and CH6 in the check boxes, and clicks (selects) the option button OB1, an application-program search request will be created. The application-program search request is indicative of retrieving at least one application program 9, which is associated with either “barcode” or “two-dimensional code” as the reading target, and associated with either “master-file reference” or “master-file registration” as the file-handlings.

On the other hand, if a user checks CH1, CH2, CH5 and CH6 in the check boxes, and clicks the option button OB2, an application-program search request will be created. The application-program search request is indicative of retrieving at least one application program 9, which is associated with both “barcode” and “two-dimensional code” as the reading target, and associated with both “master-file reference” and “master-file registration” as the file-handlings, As illustrated in FIG. 4, because stock-take is entered in the keyword box 13 and the option button OB1 is clicked by a user, an application-program search request is created. The application-program search request is indicative of retrieving at least one application program 9, which is associated with either “barcode” or “two-dimensional code” as the reading target, and associated with either “master-file reference” or “master-file registration” as the file-handlings.

Then, user's click on the search command button 14 allows the created application-program search request to be sent from the Web browser 11 to the server 2 through the Internet 1 in step S3.

In step S4, the Web server 5 of the server 2 receives the application-program search request sent from the client 3 and passes it to the search engine 6. In step S4, the search engine 6 searches the database 8, and if it is determined that at least one application program 9 meets the application-program search request, passes, to the Web server 5, the search result including information representing the at least one application program 9. In step S4, the Web server 5 creates a Web page representing the search result in, for example, list format, and downloads the created Web page to the client 3 as an application-program search result Web page W5.

Note that, in the step S4, if it is determined that no application programs 9 satisfy the application-program search request, the search engine 6 finds at least one application program 9 that has the lowest number of unsatisfied search requirements in the application-program search request. Then, the search engine 6 passes the at least one application program 9 to the Web server 5.

The Web browser 11 of the client 3 receives the downloaded application-program search result Web page W5 and graphically displays it on the screen of the display device 3a in step S5.

FIG. 5 schematically illustrates an example of the application-program search result Web page W5 displayed on the screen of the display device 3a. As illustrated in FIG. 5, the application-program search result Web page W5 consists of the list representing the number and names of application programs 9 found by the search engine 6.

In the example illustrated in FIG. 5, the names of application programs 9 of the fixed assets stock-take program 9al, the document stock-take program 9a2, and the stock-take data registration program 9a3 are clickably displayed to be linked to the corresponding program structure Web pages W2 on the screen of the display device 3a together with the contents of them, respectively.

The user views the application-program search result Web page W4 displayed on the screen of the display device 3a, and determines whether at least one of the application programs 9 in the Web page W4 meets the entered search requirements in step S6. If it is determined that one of the application programs 9 in the Web page W4 for example meets the entered search requirements in step S6, the user evaluates the one of the application programs 9 meeting the entered search requirements using the program simulator 7 in step S7.

Specifically, if it is determined that the fixed assets stock-take program in the Web page W4 illustrated in FIG. 5 for example meets the entered search requirements in step S6, the user clicks the name of the fixed assets stock-take program 9a1 on the Web page W4. This allows the Web server 5 to pick up the program structure Web page W2 linked to the name of the fixed assets stock-take program 9a1 and to download the Web page W2 to the Web browser 11 so that the Web page W2 is displayed on the screen of the display device 3a in step S7a.

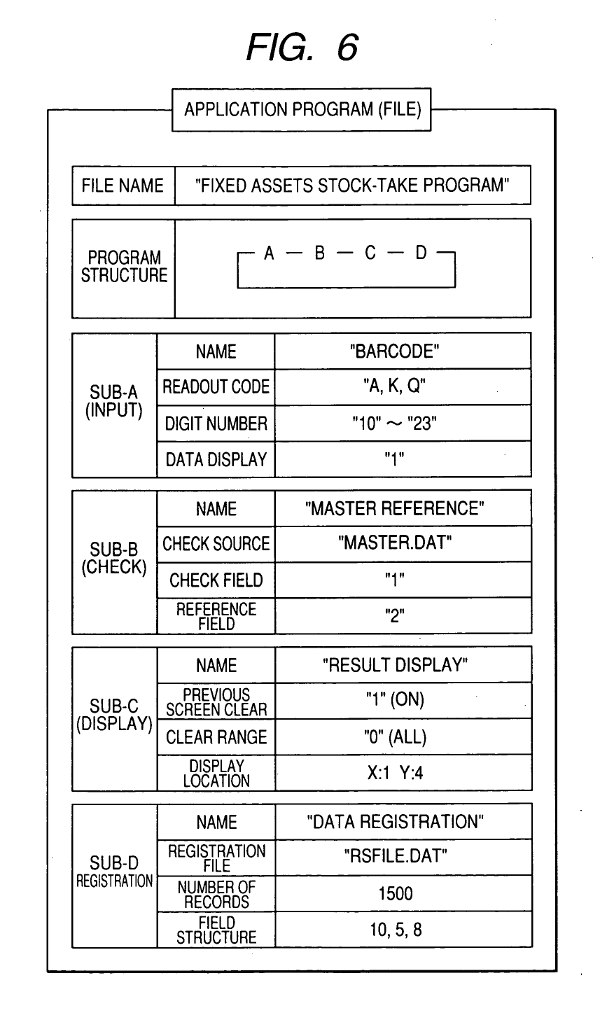

FIG. 6 schematically illustrates an example of the file structure of the fixed assets stock-take program 9a1 as a representative of the application programs 9 stored in the Web server 5. As illustrated in FIG. 6, each of the application programs 9 preferably does not consist of directly-described program codes but an assembly of parameters in file format.

Each of the application programs 9 has a structure designed to repeatedly execute a plurality of program modules 10. For example, the fixed assets stock-take program 9a1 has a structure designed to repeatedly execute subroutines SUB-A, SUB-B, SUB-C, and SUB-D as the program modules 10. The names and parameters (argument parameters) are set to correspond to the subroutines SUB-A, SUB-B, SUB-C, and SUB-D, respectively.

For example, when the fixed asserts stock-take program 9a1 calls the name of “BARCODE” (the subroutine SUB-A), the procedure (barcode input procedure) of the subroutine SUB-A uses the parameters representing a readout code, the digit number of the readout code, and whether to display the readout code. Note that the barcode will also collectively mean identification codes, such as one-dimensional code and two-dimensional codes.

In the subroutine SUB-A, the item of “A, K, Q” corresponding to the parameter of the readout code represents that the subroutine SUB-A can take JAN codes (corresponding to “A”), CODE 128 (corresponding to “K”), and QR codes (corresponding to “Q”) as the argument parameter representing the readout code. The item of “10 to 23” corresponding to the parameter of the digit number represents that the subroutine SUB-A can take the range of the digit of the readout code. In addition, the item of “1” corresponding to the parameter of the data display represents the display of the readout code. The items of the subroutine SUB-A can be reset.

Similarly, the procedure (master-file reference procedure) of the subroutine SUB-B called by the fixed asserts stock-take program 9a1 uses the argument parameters representing a check source, a check field of the check source, and a reference field thereof. The procedure (master-file reference procedure) of the subroutine SUB-C called by the fixed asserts stock-take program 9a1 uses the argument parameters representing a previous screen clear, a clear range of the clear, and a display location of a result to be displayed. Moreover, the procedure (the data registration procedure) of the subroutine SUB-D) called by the fixed asserts stock-take program 9a1 uses the argument parameters representing a registration file, the number of records in the registration file, and a field structure thereof.

Specifically, when the fixed asserts stock-take program 9a1 can be performed by the application-program execution system 4c1 or 4c2 and an identification code (JAN code, CODE 128, or QR code) written on the label attached to a goods placed on a shelf in the store is scanned by a reading terminal 4, the subroutine SUB-A is called by the fixed asserts stock-take program 9a1. This allows the parameter arguments depending on the readout data to be passed to the subroutine SUB-A so that the readout code is honored by the fixed asserts stock-take program 9a1.

Next, the subroutine SUB-B is called by the fixed asserts stock-take program 9a1 so that the parameter arguments are passed to the subroutine SUB-B.

Specifically, the argument parameters including the “MASTER.DAT” as the check source, the “field 1” as the check field, and the “field 2” as the reference field are passed to the subroutine SUB-B. This permits the data item stored in the field 2 of the master file (MASTER.DAT) MF corresponding to the field 1 thereof to be retrieved.

Next, the subroutine SUB-C is called by the fixed asserts stock-take program 9a1 so that the parameter arguments are passed to the subroutine SUB-C.

Specifically, the argument parameters including the “1 (ON)” as the previous screen clear, the “0 (ALL)” as the clear range, and the “X:1, Y:4” as the display location are passed to the subroutine SUB-C. This allows the previous screen, which is being displayed on the screen of the display device 4a, to be fully cleared so that the retrieved data item is displayed on the screen of the display device 4a at the location of horizontal and vertical coordinates (X and Y coordinates) of (1, 4) thereof.

Next, the subroutine SUB-D is called by the fixed asserts 5 stock-take program 9a1 so that the parameter arguments are passed to the subroutine SUB-D.

Specifically, the argument parameters including the “RSFILE.DAT” as the registration file, the “1500” as the number of records, and the “10, 5, 8” as the field structure are passed to the subroutine SUB-D. This 10 allows the readout data to be registered on a registration file named as “RSFILE.DAT”; this registration file consists of records up to 1500 each of which consists of the first, second, and third fields (field 1, field 2, and field 3). The first, second, and third fields of each record are partitioned to allow 10 bits, 5 bits, and 8 bits of data item to be stored therein, respectively.

The identification code input process based on the subroutine SUB-A, the master file reference process based on the subroutine SUB-B, the reference-result display process based on the subroutine SUB-C, and the readout code registration process based on the subroutine SUB-D are repeated every time an identification code written on the label attached to a goods placed on a shelf in the store is scanned by a reading terminal 4.

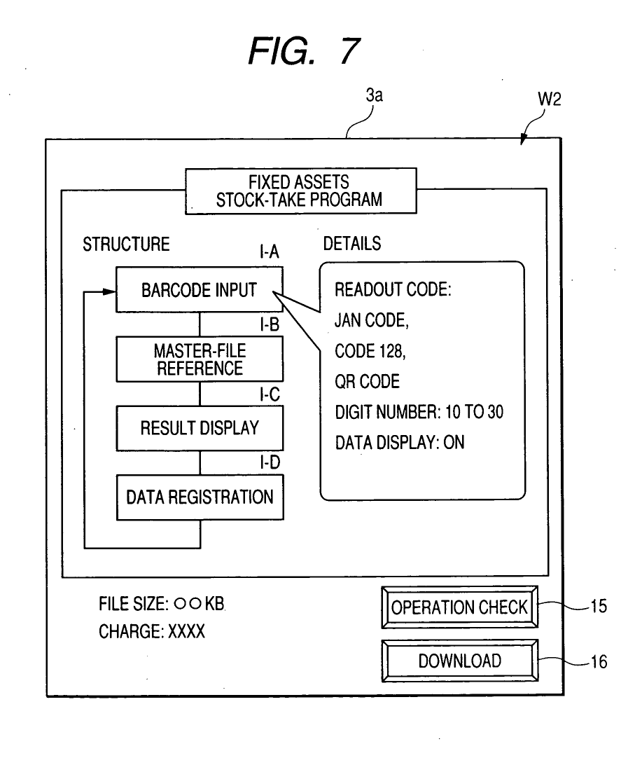

FIG. 7 schematically illustrates an example of the program structure Web page W2 linked to the name of the fixed assets stock-take program 9a1 and displayed on the screen of the display device 3a.

As illustrated in FIG. 7, the program structure Web page W2 contains icons I-A to I-D representing the names of the procedures corresponding to the subroutines (program modules) SUB-A to SUB-D. In addition, the program structure Web page W2 contains a clickable “operation check” command button 15 and a clickable “download” command button 16.

Each of the icons I-A to I-D is linked to a parameter display window DW corresponding thereto. For example, as illustrated in FIG. 7, double click on the icon I-A allows display of the parameter window DW representing the argument parameters of the readout code (JAN codes, CODE 128, and QR codes), the digit number (10 to 30), and the data display (ON).

Click on the “operation check” command button 15 permits the client 3 to send, to the server 2, a program-simulator start-up request. Click on the “download” command button 16 enables the client 3 to send, to the server 2, a corresponding application-program download request.

When the user wants to check the operation of the selected application program (program 9a1) before determining whether to purchase the selected application program 9, the user clicks on the “operation check” command button 15. The click allows the Web browser 11 and the Web server 5 to activate the program simulator 7 so that the program simulator 7 picks up the program simulator Web page W3 corresponding to the selected fixed assets stock-take program 9a1 in step S7b. The Web server 5 downloads the Web page W3 to the Web browser 11 so that the Web page W3 is displayed on the screen of the display device 3a in step S7c.

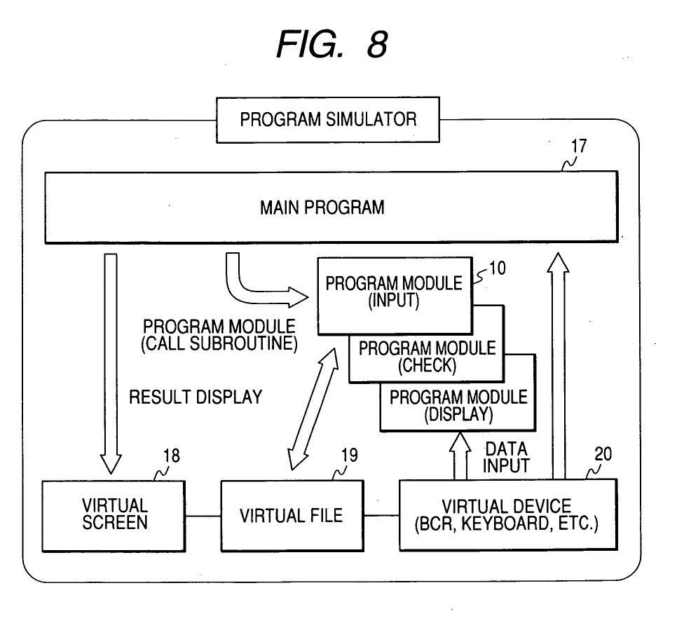

FIG. 8 schematically illustrates an example of the structure of the program simulator 7. In FIG. 8, the program simulator 7 consists predominantly of a main program 17.

The main program 17 is configured to sequentially call and run the program modules (subroutines) 10 of the selected application program 9 in the predetermined order. In the first embodiment, for example, the main program 17 is configured to sequentially call and run the subroutines SUB-A, SUB-B, SUB-C, and SUB-D of the fixed assets stock-take program 9a1 in the order of the SUB-A, SUB-B, SUB-C, and SUB-D.

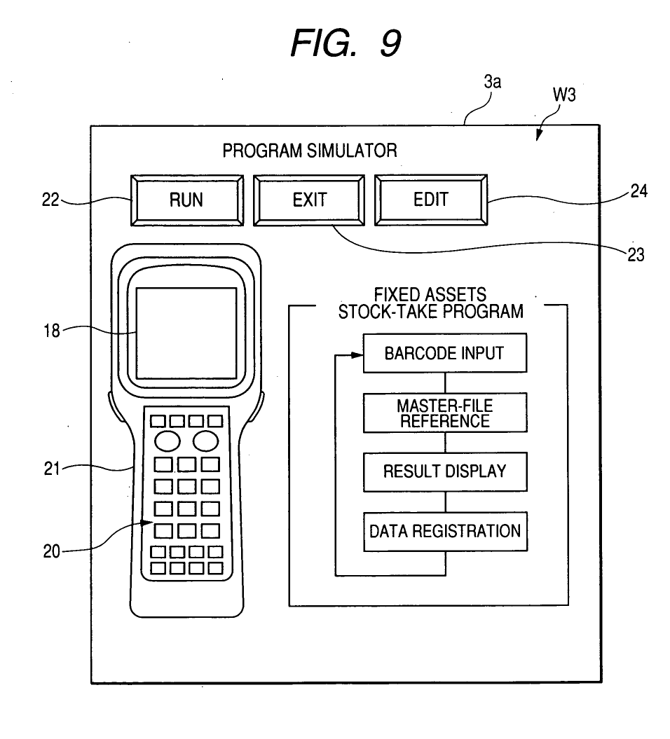

During the run of each subroutine (program module), the main program 17 is configured to display data on a virtual screen 18 that is generated on the program simulator Web page W3 (see FIG. 9 hereinafter) when displaying the data. In addition, the main program 17 is configured to refer to a virtual file (default file) 19 and to retrieve data when the running subroutine (program module) requires the data; this virtual file 19 has been preferably generated in the server 2. For example, in the virtual file 19, some of identification codes equivalent to some of them stored in the master file MF have been stored.

Moreover, when the running subroutine (program module) waits for input-operations from the reading terminal 4, the main program 17 is configured to accept input-operations using a virtual input device (on-screen input device) 20, such as an optical information reader (barcode reader: BCR), a keyboard, or the like, which is generated on the program simulator Web page W3 (see FIG. 9 hereinafter).

FIG. 9 schematically illustrates an example of the program simulator Web page W3 corresponding to the fixed assets stock-take program 9a1 and displayed on the screen of the display device 3a.

As illustrated in FIG. 9, the program simulator Web page W3 contains the virtual screen 18 and the virtual input device 20. Specifically, a picture of an input device, such as the reading terminal 4, is displayed on the Web page W3 as a virtual reading terminal 21 such that a screen of the virtual reading terminal 21 corresponds to the virtual screen 18, and a key portion thereof corresponds to the virtual input device 20. Clicks on pictures of keys of the key portion (virtual input device 20) of the virtual reading terminal 21 allow text data to be entered into the program simulator 7. Data transferred from the program simulator 7 can be displayed on the virtual screen 18 of the virtual reading terminal 21.

In addition, the program simulator Web page W3 contains a clickable “run” command button 22, a clickable “exit” command button 23, and a clickable “edit” command button 24. Moreover, on the program simulator Web page W3, like FIG. 7, the structure of the fixed assets stock-take program 9a1 (the names of the procedures corresponding to program modules SUB-A to SUB-D) are displayed.

When starting to check the operation of the selected application program (fixed assets stock-take program) 9a1, the user clicks on the “run” command button 22. The click allows the Web browser 11 and the Web server 5 to send a run request to the program simulator 7.

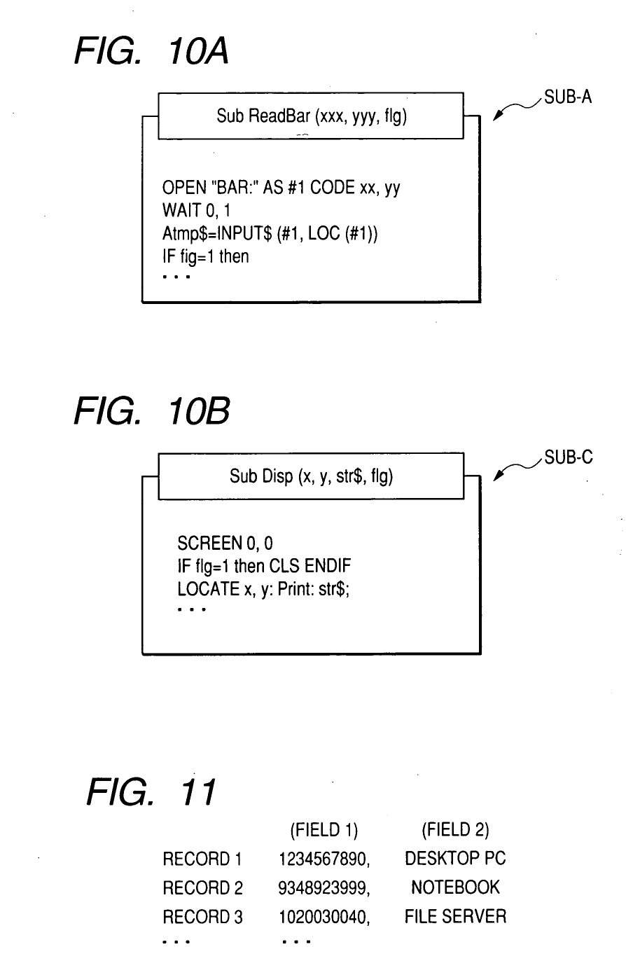

In response to receiving the run request sent from the client 3, the main program 17 of the program simulator 7 interprets the program structure of the selected application program 9, and sequentially calls and runs the program modules 10 constituting the selected application program 9 in the predetermined order (see FIG. 8). For example, FIGS. 10A and 10B schematically illustrate examples of the structures of the program modules 10 (SUB-A and SUB-C). As set forth above, each of the subroutines SUB-A and SUB-C is described in a program language that is obtained by improving the BASIC to form a subroutine.

Specifically, because the fixed assets stock-take program 9a1 to be simulated has the file structure illustrated in FIG. 6, the main program 17 of the program simulator 9a1 calls the subroutine SUB-A so that the corresponding parameter arguments are passed to the subroutine SUB-A. The subroutine SUB-A waits for input-operations based on the key portion (virtual input device) 20 of the virtual reading terminal 21.

When the user clicks a readout key of the virtual input device 20, the subroutine SUB-A retrieves at least one of the identification data from the virtual file 20, and displays the retrieved identification data on the virtual screen 18 as virtual readout data because the parameter of data display is set to “1”(ON) in step S7d.

Next, the main program 17 calls the subroutine SUB-B so that the corresponding parameter arguments are passed to the subroutine SUB-B.

Because the parameter of check source is set to the “MASTER.DAT”, the parameter of check field is set to the “field 1”, and that of reference field is set to the “field 2”, the subroutine SUB-B refers to the field 1 of each record of the master file MF to find out any one of the records corresponding to the virtual readout data. When any one of the records corresponding to the virtual readout data is found, the subroutine SUB-B refers to the field 2 corresponding to the found record, thereby retrieving the data item stored in the referred field 2 in step S7e.

For example, as illustrated in FIG. 11, it is assumed that identification codes “1234567890”, “9348923999”, and “102000030040” have been stored in the fields 1 of the records 1 to 3, respectively. In addition, it is assumed that the types “DESCTOP PC”, NOTEBOOK”, and “FILE SERVER” of the goods corresponding to the identification codes “1234567890”, “9348923999”, and “102000030040” have been stored in the fields 2 of the records 1 to 3, respectively.

In these assumptions, when the virtual readout data is “9348923999”, the subroutine SUB-B refers to the field 1 of each record of the master file MF to find out the record 2, and refers to the field 2 corresponding to the found record 2, thereby retrieving the data item of “NOTEBOOK” stored in the referred field 2.

Thereafter, the main program 17 calls the subroutine SUB-C so that the corresponding parameter arguments are passed to the subroutine SUB-C.

Because the parameter of the previous screen clear is set to the “1(ON)” and that of the clear range is set to the “0(ALL)” the subroutine SUB-C fully clears the previous screen displayed on the virtual screen 18. Next, because the parameter of the display location is set to the “X:1, Y:4”, the subroutine SUB-C displays the retrieved data item of “NOTEBOOK” on the virtual screen 18 at the location of X and Y coordinates of (1, 4) thereof as the master-file reference result in step S7f.

Thereafter, the main program 17 calls the subroutine SUB-D so that the corresponding parameter arguments are passed to the subroutine SUB-D.

Because the parameter of the registration file is set to “RSFILE.DAT” and that of the field structure is set to “10, 5, 8”, the subroutine SUB-D registers the readout data (virtual identification code) on the registration file named as the “RSFILE.DAT”.

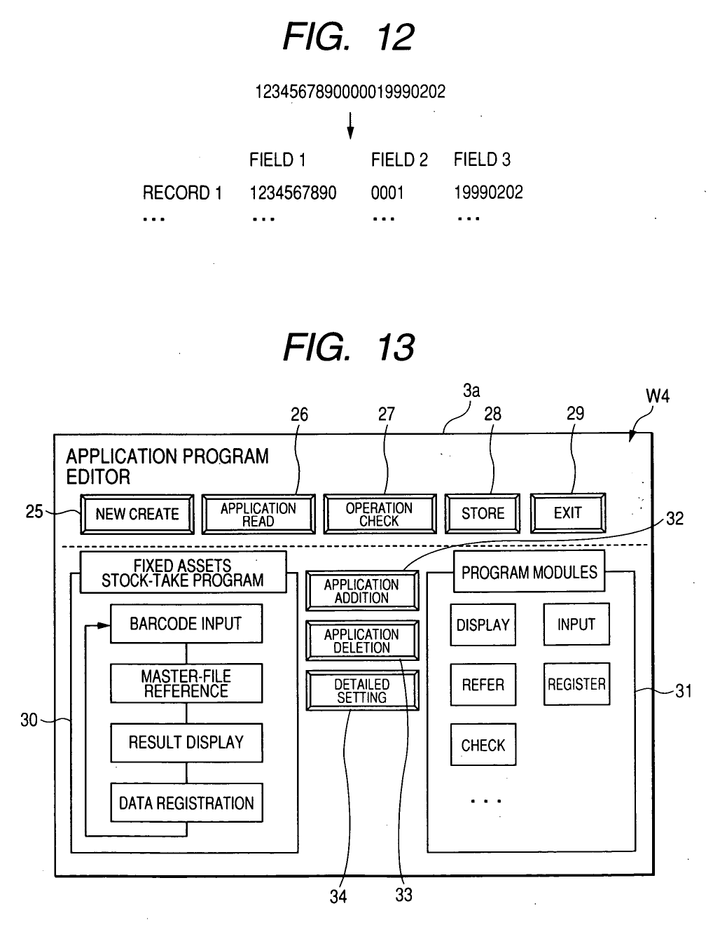

For example, when the readout data (identification code) is “1234567890” illustrated in FIG. 12, the subroutine SUB-D stores:

the readout data “1234567890” in the field 1 of the record 1 as the identification code (control numbers”;

the quantity of registration of the readout data of “1” in the field 2 of the record 1; and

data item representing the registration date of the readout data of “1990202” in the field 3 of the record 1. Note that keyboard-entry is set to the quantity of registration of an argument parameter for the subroutine SUB-D, the subroutine SUB-D can store, in the field 2 of the record 1, data item entered by the click of the key portion 20 of the virtual reading terminal 21.

As described above, the user can evaluate the operations of the fixed assets stock-take program 9a1 based on the result data displayed on the virtual screen 18 of the virtual reading terminal 21 in step S7g.

When it is evaluated that the check of the operations of the fixed assets stock-take program 9a1 is OK (the determination is YES in step S7g), the user clicks on the “exit” command button 23. The click allows the Web browser 11 to display the program structure Web page W2 on the screen of the display device 3a. Thereafter, the user clicks the “download” command button 16. The click permits the Web browser 11 to send, to the server 2, the download request of the application program 9a1 in step S7h.

When receiving the download request from the client 3 (Web browser 11), the Web server 5 determines whether the application program 9a1 as the download target is required to be available to the public in step S8 of FIG. 3B.

If the application program 9a1 has been already available to the public, the determination in step S8 is NO so that the Web server 5 calculates a normal fee of the application program 9a1 in step S9.

The normal fee of the download of the application program 9a1 can be calculated based on size information of the application program 9a1. In the first embodiment, the size information preferably includes the number of the program modules 10 constituting the application program 9a1 and/or the total data-storage capacity required to store the application program 9a1.

In addition, the size information can include the number of program modules 10 added to the application program 9a1.

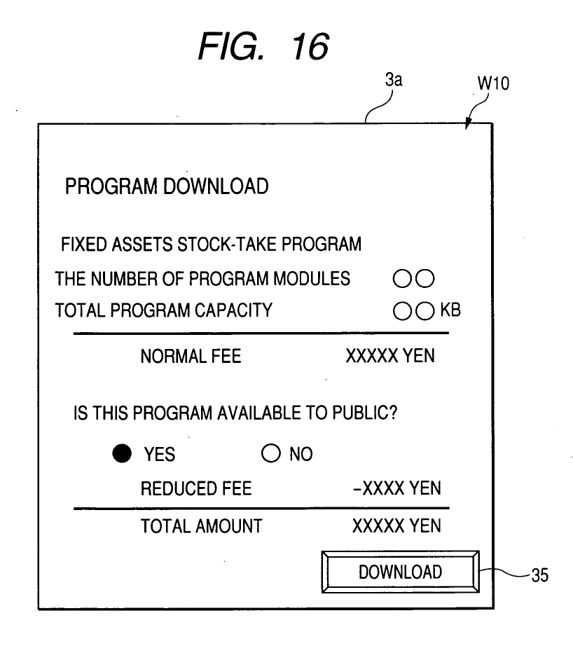

The Web server 5 creates a program download confirmation Web page W10 (see FIG. 16 hereinafter as an example) representing the calculated normal fee to download it to the client 3 in step S9.

The Web browser 11 of the client 3 receives the program download confirmation Web page W10 and displays it on the screen of the display device 3a in step S9.

As a result of confirming the normal fee of the download of the application program 9a1, if it is determined that the charge of the normal fee is OK, the user clicks on a clickable “download” command button 35 on the program download confirmation Web page W10. The click permits the Web browser 11 and the Web server 5 charges the normal fee to the user using any one of well-known charging systems in step S9.

For example, the Web server 5 has already received and stored the user's credit card numbers, and a provider (application program provider) of the application program 9a1 will charge the normal fee to the user's credit card. For another example, the user has already purchased digital money signed by a bank and stored it in the client 3. In step S9, the Web server 5 sends a payment request of the normal fee to the client 3, and the client 3 sends the digital money corresponding to the normal fee to the Web server 5. As a result, the provider of the application program 9a1 deposits the digital money at the bank.

After the charge of the normal fee to the user, the Web server 5 downloads the application program 9a1 to the client 3 in step S10.

In contrast, in step S6, if it is determined that no application programs 9 in the Web page W4 meet the entered search requirements (the determination in step S6 is NO), the user determines whether it is required to newly create an application program by determining whether at least one of the application programs 9 in the Web page W4 has the lowest number of unsatisfied search requirements in step S11.

If it is determined that at least one of the application programs 9 in the Web page W4 has the lowest number of unsatisfied search requirements (the determination in step S11 is YES), the user edits the at least one of the application programs 9 to completely meet the entered search requirements in step S12.

Because each of the application programs 9 is a combination of some of the program modules 10, it is possible to add a program module 10 to an existing application program 9 and/or replace a program module 10 constituting part of an existing application program 9 with another one.

Specifically, if it is determined that no application programs 9 in the Web page W4 meet the entered search requirements (the determination in step S6 is NO) and that at least one of the application programs 9 has the lowest number of unsatisfied search requirements (the determination in step S11 is YES), the user causes the Web browser 11 to display the program simulator Web page W3 on the screen of the display device 3a, and clicks on the “edit” command button 24 in step S12. The click allows the Web server 5 to pick up the program editor Web page W4 corresponding to, for example, the fixed assets stock-take program 9a1 and to download the Web page W4 to the Web browser 11 so that the Web page W4 is displayed on the screen of the display device 3a in step S13.

Because the “edit” command button 24 is displayed on the program simulator Web page W3, click of the “edit” command button 24 allows the program simulation mode of the server system SC to be immediately shifted to the program editor mode. This makes it possible to immediately edit (correct) the application programs 9 based on the result of simulation.

FIG. 13 schematically illustrates an example of the program editor Web page W4 linked to the fixed assets stock-take program 9a1 and displayed on the screen of the display device 3a.

As illustrated in FIG. 13, the program editor Web page W4 operable on the GUI-based Web browser 11 contains a clickable “new create” command button 25, a clickable “application read” command button 26, a clickable “operation check” command button 27, a clickable “store” command button 28, and a clickable “exit” command button 29. The program editor Web page W4 also contains a program-structure display field 30, which is similar to FIGS. 7 and 9, and a program-module display filed 31. In addition, the program editor Web page contains a clickable “application addition” command button 32, a clickable “application deletion” command button 33, and a clickable “detailed setting” command button 34, which are located between the program-structure display field 30 and the program-module display field 31.

For example, the program-module display field 31 contains icons corresponding to program modules 10 stored in the database 8. The icons of “display”, “input”, “reference”, and “registration” correspond to the subroutines SUB-A, SUB-B, SUB-C, and SUB-D to which default values are set as the corresponding argument parameters of them, respectively. The icon of “check” corresponds to a program module (subroutine SUB-E) that preferably can be configured to check whether a data item referred by the procedure of the master file reference process based on the subroutine SUB-B agrees with a data item actually stored in the master file AS at the location corresponding to a readout code input by the identification code input process based on the subroutine SUB-A.

When the user wants to add the procedure of the program module SUB-E, the user handles the mouse 3c to drag the “check” icon and drop it in the program-structure display field 30. The drag and drop allow the Web browser 11 to send, to the server 2, a request for combining the program module SUB-E into the fixed assets stock-take program 9a1 in step S14.

The Web server 5 and the search engine 6 search the database 8 to retrieve the program module SUB-E therefrom, and the Web server 5 determines whether the retrieved program module SUB-E is proper. If it is determined that the retrieved program module SUB-E is proper, the Web server 5 combines the program module SUB-E into the fixed assets stock-take program 9a1 at the most appropriate order thereof, thereby creating an original fixed assets stock-take program 9a1A in step S15.

For example, the “check” program module SUB-E is combined into the fixed assets stock-take program 9a1 after the program module SUB-B and before the program module SUB-C. As a result, the Web server 5 creates Web information representing the structure of the original fixed assets stock-take program 9a1A, and downloads it to the client 3. The Web browser 11 of the client 3 receives the Web information to display it on the program-structure display field 30 of the Web page W4 in step S15.

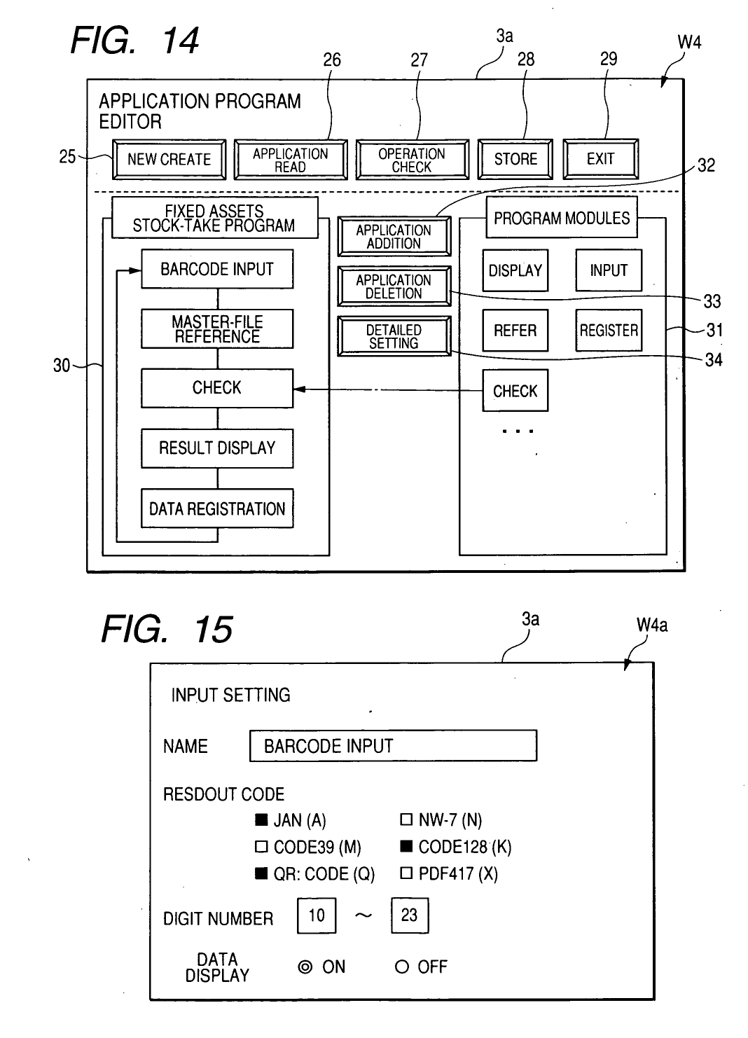

As a result, as illustrated in FIG. 14, the icon “check” is combined between the “master-file reference” icon and the “result display” icon of the fixed assets stock-take program 9a1. This allows the user to recognize the “check” program module SUB-E, which the user wants to add to the program 9a1, is reliably combined into the program 9a1.

Moreover, because as the argument parameters of the “check” program module SUB-E, the default values are set, if the original fixed assets stock-take program 9a1A may not meet the search requirements, the user clicks on the “detailed setting” command button 34. The click allows the Web browser 11 to display a detailed setting Web page W4a linked to the Web page W4 on the screen of the display device 3a.

FIG. 15 schematically illustrates an example of the detailed setting Web page W4a for setting, for example, the arguments parameters of “readout code”, “digit number”, and “data display”. The GUI-based Web browser 11 allows the user to set the argument parameters on the Web page W4a.

After the argument parameter setting, the user clicks on the “store” command button 28. This permits the Web browser 11 and the Web server 5 to update the default values of the argument parameters of the program module SUB-E to the input parameters.

After the edit operations of the application program 9a1, the user clicks on the “operation check” command button 27. This makes it possible to perform the simulation of the operations of the application program 9a1A in step S 16, which is substantially equivalent to the operations illustrated in steps S7b to S7f of FIG. 3A.

Like the operations in step S7g, the user can evaluate the operations of the original fixed assets stock-take program 9a1A based on the result data displayed on the virtual screen 18 of the virtual reading terminal 21 in step S16.

When it is evaluated that the check of the operations of the fixed assets stock-take program 9a1A is OK (the determination is YES in step S16), the user clicks on the “exit” command button 23. The click allows the Web browser 11 to display the program structure Web page W2 on the screen of the display device 3a. Thereafter, the user clicks the “download” command button 16. The click permits the Web browser 11 to send, to the server 2, the download request of the application program 9a1A in step S7h.

When receiving the download request from the client 3 (Web browser 11), the Web server 5 determines whether the application program 9a1A as the download target is required to be available to the public in step S8 of FIG. 3B.

If the application program 9a1A has not been available to the public yet, the determination in step S8 is YES so that the Web server 5 registers the application program 9a1A in the database 8 to be available to the public, and calculates a reduced fee of the application program 9a1A in step S17.

The reduced fee of the download of the application program 9a1A can be calculated by subtracting a predetermined cash discount from the normal fee of the application program 9a1A.

The Web server 5 creates the program download confirmation Web page W10 representing the calculated normal fee and the reduced fee to download it to the client 3 in step S17 (see FIG. 16).

The Web browser 11 of the client 3 receives the program download confirmation Web page W10 and displays it on the screen of the display device 3a in step S17.

As a result of confirming the reduced fee of the download of the application program 9a1A, if it is determined that the charge of the reduced fee is OK, the user clicks on the clickable “download” command button 35 on the program download confirmation Web page W10. The click permits the Web browser 11 and the Web server 5 charges the reduced fee to the user using any one of well-known charging systems in step S17 set forth above.

After the charge of the normal fee to the user, the Web server 5 downloads the application program 9a1A to the client 3 in step S10.

The application program downloaded to the client 3 can be downloaded to the reading terminals 4 based on the operations of the communication tool 12.

Note that, in step S8, if a request that the program 9a1A is kept private is sent from the client 3 to the Web server 5, the determination in step S8 is NO so that the Web server 5 registers the application program 9a1A on the database 8 to be kept private, and calculates a normal fee of the application program 9a1A in step S17.

Returning to step S11, in contrast, if it is determined that no application programs 9 have the lowest number of unsatisfied search requirements (the determination in step S11 is NO), the user clicks on the “new create” command button 25 on the program editor Web page W4. The click allows a predetermined application-program template linked to the Web page W4 to be displayed thereon in step S18. This makes it possible for the user to edit the application-program template by drag and drop of some of desirable program modules 10 displayed in the program-module display field 31 set forth above. Thereafter, the user clicks on the “operation check” command button 27 (see step S16 in FIG. 3A).

As set forth above, when the application-program execution system 4c1 has been installed in each of the reading terminals 4, the application program is directly downloaded to each of the reading terminals 4 by the communication tool 12. The application-program execution system 4c1 executes the source code of the application program by translating parameters therein line by line.

Otherwise, when the application-program execution system 4c2 has been installed in each of the reading terminals 4, the application program is translated into an object code by the communication tool 12, and the object code is downloaded into each of the reading terminals 4 thereby. The application-program execution system 4c2 runs the object code directly.

Registration of the created original application program 9a1A based on the downloaded application program 9a1 on the server 2 (database 8), which is configured to be available to the public, allows the fee of the download of the application program 9a1 to be reduced. This is because the user's created original application program designed to be available to the public permits other users to use it, making it possible to contribute increase of the number of users of the server-client system SC and improvement of enlargement of the system SC.

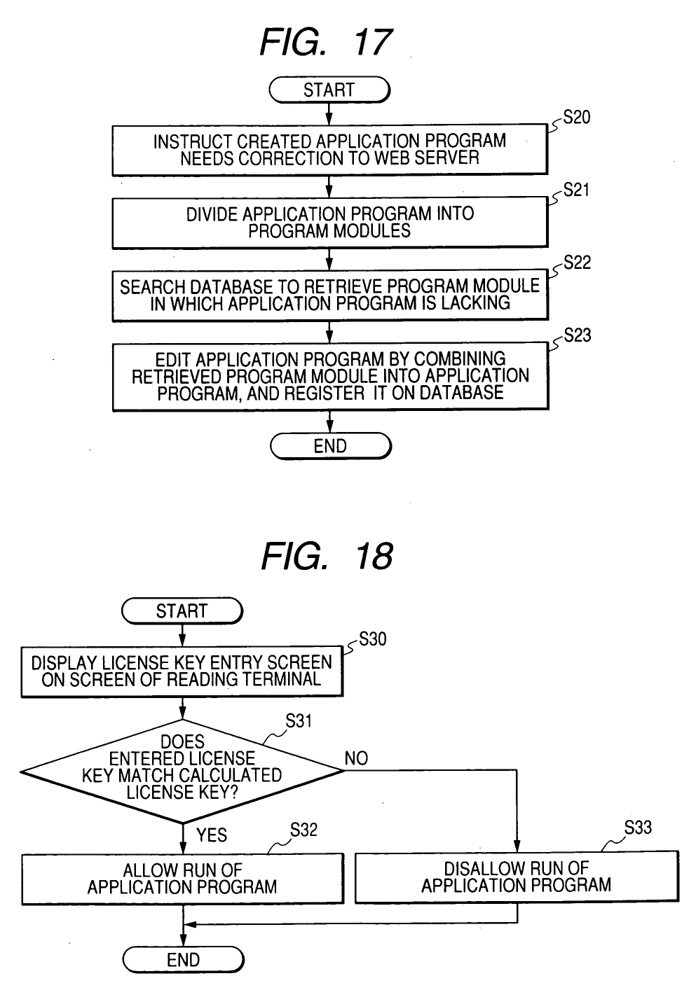

Note that, when registering a created original application program 9 on the server 2, it is possible for the user to instruct that the created original application program 9 needs correction to the Web server 5 (see step S20 of FIG. 17.

In this case, the Web server 5 divides the application program 9 into the program modules 10 in step S21, and the Web server 5 and the search engine 6 search the database 8 to retrieve at least one program module in which the application program 9 is lacking to meet the user's search requirements in step S22.

Next, the Web server 5 edits the application program 9 by combining the retrieved at least one program module into the application program 9 so as to meet the user's search requirements, thereby registering it on the database 8 in step S23.

This modification allows the user not to edit the created application program to completely satisfy the user's search requirements, making it possible to reduce the burden on users.

Before registering the created application program, the Web server 5 can perform simulation of the created application program. This allows the user to view the actual operations of the created application program, making it possible to reliably register the created application program that functions well on the database 8.

Note that, it can be designed that an application program 9 downloaded to each reading terminal 4 operates in trial mode so that, after a predetermined period has passed, use of the downloaded application program 9 is limited. In this case, for sequentially use the application program 9, a release key to release the limitation must be required. This can accept payment of the normal or reduced fee by means of non-real-time way, such as a bank transfer, making it possible for the server-client system SC to meet payment of the normal or reduced fee by means of non-real-time way.

The release key has been notified to an authorized user. The release key is determined as a unique value obtained by subjecting a program ID (Identification) to predetermined mathematical calculations. The program ID is obtained based on both a unique ID number allocated to the downloaded application program and a serial number registered on the user's reading terminal 4. Each application program is capable of subjecting a program ID (Identifier) to the predetermined mathematical calculations to obtain the release key (unique value) corresponding to the program ID.

Specifically, after predetermined period has passed from the download of the application program to the reading terminal 4, when running the downloaded application program, the downloaded application program causes the reading terminal 4 to display a release key entry screen S on the screen of the display device 4a thereof in step S30 of FIG. 18.

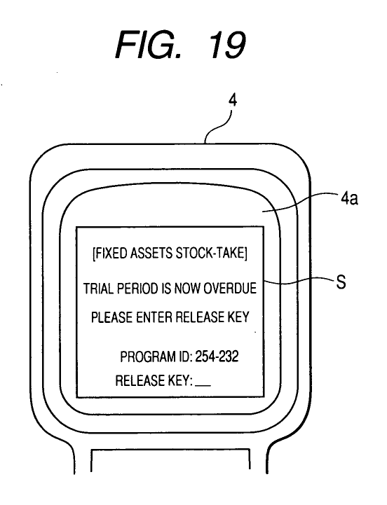

FIG. 19 schematically illustrates an example of the release key entry screen S displayed on the screen of the display device 4a. On the entry screen S, the program ID corresponding to the unique ID number allocated to the downloaded application program and the serial number registered on the reading terminal 4 is displayed. In addition, a prompt appears on the entry screen S to signal to the user that the terminal 4 is ready to receive input of a release key.

When a release key is entered from the key portion 4b by the user's operation, the downloaded application program causes the reading terminal 4 to determine whether the entered release key matches the release key data calculated by subjecting the program ID to the predetermined mathematical calculations in step S31.

If it is determined that the entered release key matches the release key data (the determination in step S31 is YES), the downloaded application program allows the reading terminal 4 to run it in step S32, but otherwise, the downloaded application program disallows the reading terminal 4 to run it in step S33.

For example, when a unauthorized user installs, in the unauthorized user's reading terminal, the application program, which has been downloaded by another authorized user, even if the unauthorized user enters a value as the license key, the entered value does not match the release key data calculated by subjecting the program ID of another authorized user to the predetermined mathematical calculations. This disallows the unauthorized user to use the application program. Similarly, when the application program downloaded to an authorized user's reading terminal is illegally copied to another reading terminal, even if the release key is entered to another reading terminal, because the program ID of the authorized user's reading terminal does not match that of another reading terminal. This disallows illegal use of the downloaded application program.

As described above, in the first embodiment, the server-client system SC is configured to permit:

the client 3 to access the server 2 to send search requirements thereto so that the server 2 searches the database 8 to retrieve information indicative of some of the application programs to meet the search requirements;

the client 3 to display the information on the screen of the display device 3a thereof; and

the server 2 to download at least one of some of the application programs to the client 3 when a download request for downloading the at least one of some of the application programs is sent from the client 3.

This makes it possible to prevent at least one application program that meets the search requirements from being redundantly developed if the at least one application program has been registered on the database 8.

In addition, if the application programs that have already registered on the database 8 do not meet the search requirements, the GUI-installed client 3 displays, on the screen of the display device 3a thereof, the program modules 10 stored in the database 8. This allows the client 3 to send, to the server 2, instructions to edit or newly crease an application program, which meets the search requirements, based on at least one of the selected program modules 10 displayed on the client 3. It is therefore possible to reduce the burden on users when newly creating application programs.

When an application program 9 is created by the server 2 using the user's instructions, it is possible to make the created application program 9 available to the public. This can provide the server-client system SC for increasing the number of application programs that the server 2 have posted on the Internet 1, making it possible to develop it as a business model.

Moreover, the server-client system SC is configured to simulate a user-selected application program 9 or an edited application program 9 based on the user's instructions on the GUI-installed client 3, allowing a user to check the quality of the user-selected or edited application program 9. This makes it possible to determine the quality of user-selected or edited application program 9 on the actual operating environment, thereby properly determining the quality of user-selected or edited application program 9. The simulation of user-selected or edited application program 9 is carried out by the server 2, making it possible to reduce the burden on uses for simulating the user-selected or edited application program 9.

### Second Embodiment

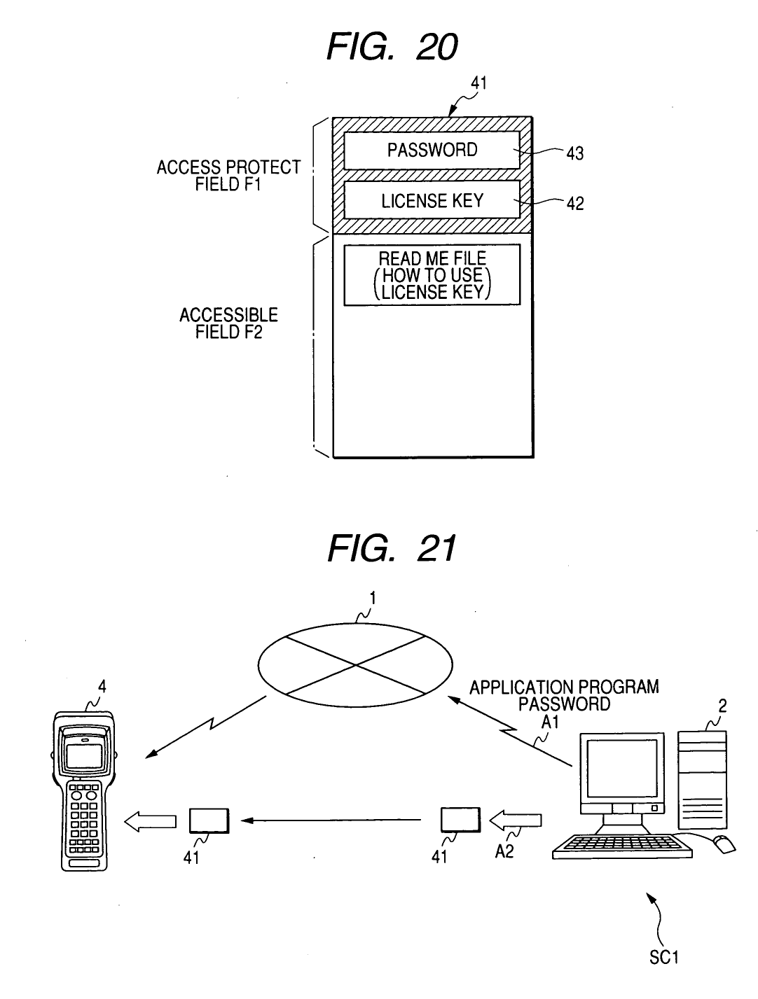

A second embodiment of the present invention will be described hereinafter with reference to FIGS. 20 to 24.

In the first embodiment, a release key allows the limitation of an downloaded application program 9 in trial mode to be released. In the second embodiment, the server 2 issues a license to users, and a downloaded application program 9 can be made available if the license is authenticated.

Note that when a user with an authorized license replaces the user's reading terminal 4 into a new one due to a failure and the like, the user needs to get a unique license key for authenticating the license again. Specifically, even through the user has already received the authorized license to use the downloaded application program 9 and uses it within the licensed rights, the user must get a unique license key for authenticating the license again, which may be very intrusive for the user.

The second embodiment has been made on the background set forth above. Specifically, in the second embodiment, a license key has been stored in a storage medium, such as a SD (Secure Digital) memory card®, and the storage medium is issued to a user. That is, the user can get the license key stored in the storage medium therefrom, provided that a predetermined authentication procedure is performed by a reading terminal 4 whose storage medium slot is accepting the storage medium.

FIG. 20 schematically illustrates an example of the structure of storage area of the storage medium.

In FIG. 20, the storage medium 41 includes an access protect field F1 that is password-protected from writing and reading, and an accessible field P2 that is free from writing and reading.

The access protect field F1 contains a password register 43 and has stored therein a license key 42.

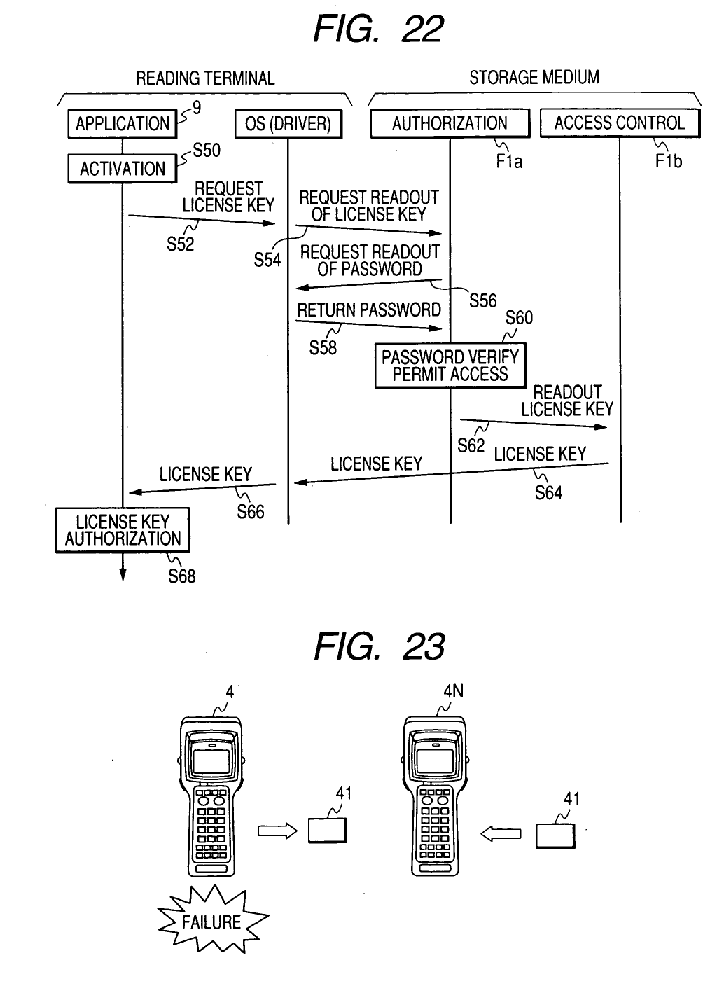

In addition, the access protect field F1 has an authorization function F1a (see FIG. 22 hereinafter) of permitting external access and/or external writing to/into the access protect field F1 when a password as an example of items of authentication information written into the password register 43 is authorized. The access protect field F1 also has an access control function F1b (see FIG. 22) of actually controlling the external accesses with respect to the access protect field F1. The license key 42 is so created by the server 2 as to include a password. In the accessible field F2, a “Read me” file including text data of how to use license key, user data, and programs have been stored.

FIG. 21 schematically illustrates an example of the structure of a server-client system SC1 according to a second embodiment of the present invention. In FIG. 21, the functions of the client 3 have been installed in the reading terminal 4 so that the reading terminal 4 can directly communicate with the server 2 through the Internet 1. This results in that the client 3 is omitted.

In addition to the structure and operations of the server 2 described in the first embodiment, when downloading a user-selected or edited application program 9 to the reading terminal 4, the server 2 has a first function Al of sending a password to the reading terminal 4 simultaneously with the download. The password is received by an operating system (OS) installed in the reading terminal 4 to be stored in a predetermined storage area of the reading terminal 4.

When sending the password to the reading terminal 4, the server 2 has a second function A2 of issuing a license key 42 corresponding to the downloaded application program 9 and containing the sent password in file format. A provider uses a reader/writer for storage media to write the license key (license key file) 42 into the access protect field F1 of the storage medium 41, and delivers the storage medium 41 to the user of the reading terminal 4 to which the password has been sent.

In the second embodiment, when being downloaded to the reading terminal 4, each application program operates in trial mode so that, after a predetermined period has passed, use of the downloaded application program 9 is limited. In this case, for sequentially use the application program 9, the license key 42 corresponding to the downloaded application program 9 must be required.

Specifically, each of the application programs 9 is configured to cause, when the OS of the reading terminal 4 runs an application program 9 downloaded to the reading terminal 4, the OS to perform a predetermined authentication procedure for checking for the license key 42 while the storage medium 41 is being accepted in a storage medium slot of the reading terminal 4. Note that the application program running function and/or the license key checking function can be installed in a driver for peripherals; this driver has been installed in the reading terminal 4.

Storage of the license key 42 in the access protect field F1 of the storage medium 41 allows third party not to read the license key 42 when the user has lost the storage medium 41. This makes it possible to prevent the license key 42 from being illegally used by third party.

When receiving the storage medium 41, the user inserts the storage medium 41 into a storage medium slot of the reading terminal 4 in which the password has been stored. While the storage medium 41 is being accepted in the slot, the OS of the reading terminal 4 reads out the password stored in the storage area of the terminal 4, and outputs the readout password to the password register 43 of the storage medium 41.

If it is determined that the password output to the password register 43 is authenticated, the storage medium 41 reads out the license key 42 stored in the access protect field F1. Then, the storage medium 41 outputs the readout license key 42 to the reading terminal 4 so that the reading terminal 4 receives the license key 42 and uses the application program 9 based on the license key 42 even after the predetermined period has passed.

FIG. 22 schematically illustrates a procedure for obtaining the license key 42 by the reading terminal 4. In FIG. 22, when the application program 9 stored in the reading terminal 4 is activated by the OS in step S50, the application program 9 requests a license key to the OS in step S52. Note that if the driver includes the application program running function and the license key checking function, the application program 9 requests a license key to the driver in step S52.

When accepting the license key request, the OS of the reading terminal 4 requests readout of the license key to the storage medium 41 in step S54. The authorization function F1a of the storage medium receives the license-key readout request and requests readout of the password to the OS of the reading terminal 4 in response to the received request in step S56.

The OS of the reading terminal 4 receives the password readout request and reads out the password stored in the storage area of the terminal 4 in response to the received request, thereby returning the readout password to the password register 43 of the storage medium 41 in step S58.

When the password returned from the OS is input to the password register 43 to be stored therein, the authorization function F1a of the storage medium 41 determines whether the password stored in the password register 43 matches the password contained in the license key 42 stored in the access protect field F1 in step S60.

When it is determined that the password stored in the password register 43 matches the password contained in the license key 42, the authorization function F1a permits external accesses from the OS to the access protect field F1 in step S60. Specifically, the access control function F1b of the storage medium 41 reads out the license key 42 stored in the access protect field F1 therefrom in step S62, and gives it to the OS in step S64.

The OS receives the license key 42 given from the storage medium 41 and passes the license key 42 to the application program 9 in step S66. The application program 9 therefore receives the license key 42 from the storage medium 41. As a result, the application program 9 sequentially operates based on the license key 42 even after the predetermined period has passed. When the application program 9 fails to receive the license key 42, the application program 9 aborts its operation thereafter.

When the reading terminal 4 is unusable due to a failure and the like, as illustrated in FIG. 23, the user removes the storage medium 41 from the terminal 4. Next, the user inserts the removed storage medium 41 into a storage medium slot of a new reading terminal 4N in which the same downloaded application program 9 or the copy thereof has been stored. This allows the new reading terminal 4N to authorize the license key 42 stored in the storage medium 41, making it possible to run the downloaded application program 9 or the copy thereof to continue the application corresponding to the program 9.

As described above, in the second embodiment, the license key 42 has been stored in the access protect field F1 that is password-protected in the storage medium 41. When the authenticated password is output from the terminal 4 to the storage medium 41 while the medium 41 is being accepted in the storage medium slot of the terminal 4, the license key 42 is permitted to be given to the terminal 4 from the storage medium 41. This makes it possible to prevent the storage medium 41 in which a license key is transparently stored from being copied. In addition, it is possible to provide licenses to users by an increment of the number of license keys 42 and to securely administrate the licenses issued to the users.

Install of the password output function from the storage medium 41 to the password register 43 in step S58 and the password passing function from the storage medium 41 to the application program 9 in step S66 in the OS of the reading terminal 41 allows the burden of the application program 9 to be reduced.

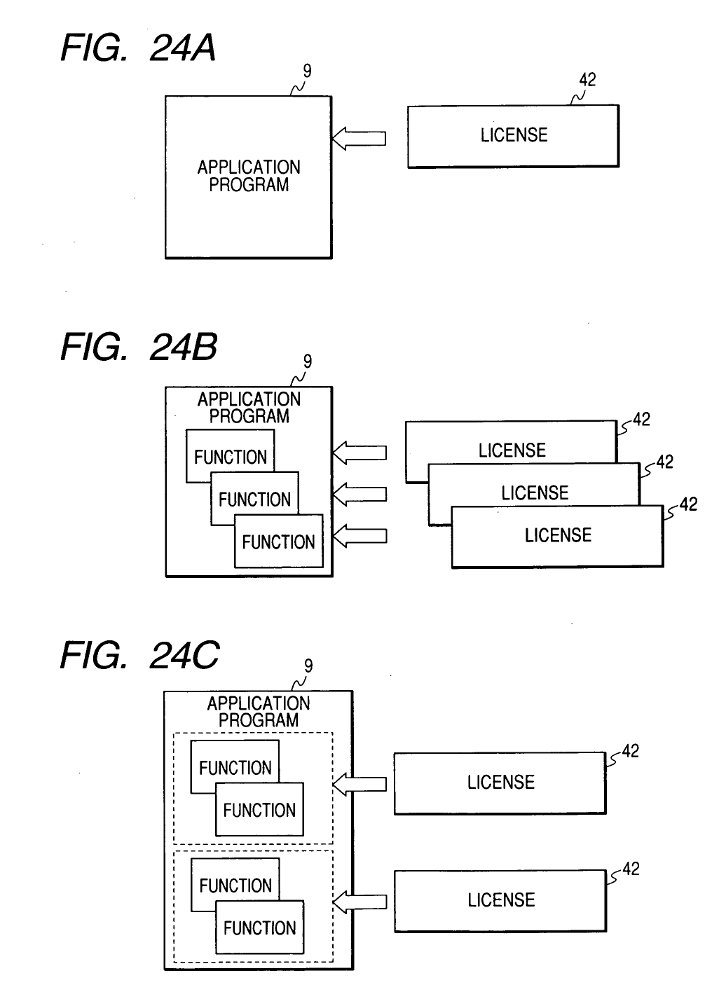

Note that, as a configuration for giving a license (license key 42) to a user, licenses (license keys 42) are given to downloaded application programs 9 in one-to-one relationship in the second embodiment (see FIG. 24A). The present invention is not limited to the configuration. Specifically, licenses (license keys 42) can be given to functions of a downloaded application program 9, respectively (see FIG. 24B), or a license (license key) can be given to a plurality of functions of a downloaded application program 9 (see FIG. 24C).

The present invention is not limited to the first and second embodiments, and can be modified and/or enlarged.

Specifically, as means for installing the GUI environment in the client 3, Java servlet, Java applet, Java script, CGI and the like can be used.

Like the second embodiment, the functions of the client 3 can be installed in the reading terminal 4. In this modification, the reading terminal 4 can directly run the operations illustrated in FIGS. 3A and 3B and the like.

When the edited application program is installed from the server 2 in the reading terminal 4, if the application program is not appropriated, the application program can be uploaded to the server 2. In this modification, the uploaded application program can be divided into a plurality of program modules 10, and the application program can be edited again to meet the user's search requirements.

In the second embodiment, as a method of authorizing the license key 42 stored in the storage medium 41, other authorization methods without using passwords can be used.

While there has been described what is at present considered to be these embodiments and modifications of the present invention, it will be understood that various modifications which are not described yet may be made therein, and it is intended to cover in the appended claims all such modifications as fall within the true spirit and scope of the invention.

What is claimed is:

1. A system comprising:
a server computer storing therein a plurality of programs; and
a user operable device communicable with the server computer through a communication network,
the user operable device comprising:
a request unit configured to request a search requirement that a target program should meet to the server computer through the communication network,
the server computer comprising:
a receiving unit configured to receive the search requirement;
a search unit configured to search the plurality of programs to retrieve information indicative of at least one program, the at least one program meeting the search requirement; and
a download unit configured to download the retrieved information to the user operable device through the communication network, the user operable device further comprising a first display unit configured to display the downloaded information.

2. A system according to claim 1, wherein the user operable device further comprises an edit request unit configured to request, to the server computer, an edit to the at least one program displayed by the first display unit, and the server computer further comprises an edit unit configured to edit the at least one program based on the edit request and to download the edited at least one program to the user operable device, the user operable device further comprising a second display unit configured to display the edited at least one program downloaded from the server computer.

3. A system according to claim 1, wherein the user operable device further comprises a simulate request unit configured to request, to the server computer, a simulate to the at least one program displayed by the first display unit, and the server computer further comprises a simulating unit configured to simulate the at least one program and to download the simulated result to the user operable device, the user operable device further comprising a third display unit configured to display the simulated result downloaded from the server computer.

4. A system according to claim 1, wherein the user operable device further comprises a download request unit configured to request, to the server computer, download of the at least one program displayed by the first display unit, and the server computer further comprises a program download unit configured to download the at least one program to the user operable device, the user operable device further comprising a storing unit configured to store the downloaded at least one program.

5. A system according to claim 1, wherein each of the programs causes the user operable device to perform a particular task.

6. A system according to claim 5, wherein each of the programs is composed of a plurality of program modules, the plurality of program modules causing the user operable device to perform the particular task.

7. A system according to claim 1, wherein the server computer further comprises a program-module storing unit configured to store a plurality of program modules, each of the programs being composed of a part of the plurality of program modules, and the search unit is configured to search the plurality of program modules when it is determined that no programs meet the search requirement and to retrieve at least one program module, the at least one program module meeting the search requirement.

8. A system according to claim 1, wherein the search unit is configured to search the plurality of programs to retrieve items of information identifying a part of programs, the number of programs meeting the search requirement, the download unit is configured to create a page of information including the retrieved items of information in list format and to download the created page of information to the user operable device through the communication network, and the first display unit is configured to display the page of information.

9. A system according to claim 3, wherein the simulating unit is configured to terminate the simulation of the at least one program when a termination request is sent from the user operable device to the server computer, and the server computer further comprises an edit unit configured to allow edit of the at least one program, the edit unit becoming ready to edit the at least one program when the simulation is terminated.

10. A system according to claim 1, wherein the server computer further comprises:
a program-module storing unit configured to store a plurality of program modules, each of the programs being composed of a part of the plurality of program modules; and
a new program creating unit configured to:
search the plurality of program modules when it is determined that no programs meet the search requirement based on the search requirement to retrieve a part of the program modules;
combine the retrieved number of program modules to crease a new program, the new program meeting the search requirement; and
download the new created program to the user operable device.

11. A system according to claim 10, wherein the server computer further comprises a registering unit configured to register the new created program to be available to a public through the communication network.

12. A system according to claim 10, wherein the server computer further comprises a registering unit configured to register the new created program to be kept private.

13. A system according to claim 11, wherein the server computer further comprises an edit unit configured to:
divide the registered program into the number of program modules when a correction request to the registered program is sent from the user operable device to the server computer;
search the plurality of program modules to retrieve at least one program module in which the registered program is lacking to meet the search requirement; and
edit the registered program by combining the retrieved program module thereinto so as to meet the search requirement.

14. A system according to claim 4, wherein the server computer further comprises a charge unit configured to charge a fee to a user of the user operable terminal, the fee being determined depending on size information of the downloaded program.

15. A system according to claim 11, wherein the server computer further comprises a charging unit configured to:
determine a normal fee depending on size information of the new created program;
calculate a reduced fee by subtracting a predetermined cash discount from the determined normal fee; and
charge the reduced fee to a user of the user operable terminal.

16. A system according to claim 14, wherein the size information of the downloaded program includes the number of the program modules constituting the downloaded program.

17. A system according to claim 15, wherein the size information of the downloaded program includes the number of combined program modules.

18. A system according to claim 1, wherein the user operable device is a handheld information reading terminal.

19. A system according to claim 1, wherein the user operable device is composed of a client computer and a handheld information reading terminal, and the program downloaded from the server computer to the user operable device is downloaded to the handheld information reading terminal through the client computer.

20. A system according to claim 4, wherein the program download unit further comprises a license key issuing unit configured to:
set a license key to the at least one program, the license key permitting run of the at least one program;
configure the at least one program such that the at least one program performs to check for the license key when the at least one program is activated;
download the configured at least one program to the user operable device, the at least one program being stored in the user operable device; and
issue a storage medium in which the license key has been stored, the user operable device further comprises:
a slot in which the storage medium is acceptable; and
a program executing unit configured to:
execute the downloaded at least one program when it is checked that the storage medium is being inserted in the slot; and
cancel the execution of the downloaded at least one program when it is unconfirmed that the storage medium is being inserted in the slot.

21. A system according to claim 20, wherein the license key includes an authentication information, the license key issuing unit is configured to download the authentication information to the user operable device in addition to the configured at least one program, the at least one program and the authentication information being stored in the user operable device, and the storage medium is integrated with:
an access protect field protected by the authentication information;
a storage field in which the authentication information stored in the user operable device is input to be stored while the storage medium is being accepted in the slot; and
an authentication information control unit configured to determine whether the authentication information stored in the license key matches the authentication information stored in the storage field and to permit external accesses to the access protect field when it is determined that the authentication information stored in the license key matches the authentication information stored in the storage field.

22. A system according to claim 21, wherein the program executing unit is configured to:
output the authentication information included in the license key to the storage field of the storage medium when executing the downloaded at least one program;
read out the license key from the access protect field that is permitted to be externally accessible by the authentication information control unit after the authentication information output; and
check whether the storage medium in which the license key has been stored is being inserted in the slot.

23. A system according to claim 20, wherein each of the programs is composed of a part of a plurality of program modules, each of the programs has a plurality of functions, the license key contains a plurality of license keys, and the server computer is configured to set the plurality of license keys to either the plurality of program modules of the at least one program or the plurality of functions thereof, respectively.

24. A server system storing therein a plurality of programs and communicable with a user operable device through a communication network, the server system comprising:
a first receiving unit configured to receive a request including a search requirement that a target application program should meet and sent from the user operable device through the communication network;
a search unit configured to search the plurality of programs to retrieve information indicative of at least one program, the at least one program meeting the search requirement; and
a first download unit configured to create a first page of information indicative of the retrieved information and viewable by the user operable device and to download the first page of information to the user operable device through the communication network.

25. A server system according to claim 24, further comprising:
a second download unit configured to create a second page of information viewable by the user operable device and allowing a user to input information and to download the second page of information to the user operable device through the communication network;
a second receiving unit configured to receive a simulate request for simulation of the at least one program; and
a simulating unit configured to simulate the at least one program and to download the simulated result to the user operable device.

26. A server system according to claim 24, further comprising:
a program-module storing unit configured to store a plurality of program modules, each of the programs being composed of a part of the plurality of program modules; and
a new program creating unit configured to:
search the plurality of program modules when it is determined that no programs meet the search requirement based on the search requirement to retrieve a part of the program modules;
combine the retrieved number of program modules to crease a new program, the new program meeting the search requirement; and
download the new created program to the user operable device.

27. A method of providing at least one of a plurality of programs to a user operable device through a communication network, the method comprising:
receiving a request including a search requirement that a target program should meet and sent from the user operable device through the communication network;
searching the plurality of programs to retrieve information indicative of at least one program, the at least one program meeting the search requirement;
creating a first page of information indicative of the retrieved information and viewable by the user operable device; and
downloading the first page of information to the user operable device through the communication network.
